(19) United States
(12) Patent Application Publication
(10) Pub. No.: US 2008/0173534 A1
(43) Pub. Date: Jul. 24, 2008

(54) Method of treating unburnt methane by oxidation by plasma

(76) Inventors: Stephanie Da Costa, Pantin (FR); Emmanuel Tena, Varenne (FR); Patrick Da Costa, Pantin (FR); Rui Miguel Jorge Chelhlo Marques, Paris (FR); Gerald Djaga Mariedassou, Igny (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/978,524

(22) Filed: Oct. 29, 2007

(30) Foreign Application Priority Data
Oct. 30, 2006 (FR) 0654625

(51) Int. Cl. B01J 19/08

(52) U.S. Cl. 204/157.44

(57) ABSTRACT

A method of treating a methane residue in a gas mixture at a temperature lying in the range 200° C. to 500° C. and including at least methane at a concentration lying in the range 50 ppm to 2500 ppm and oxygen at a concentration lying in the range 0.5% to 12% by volume. According to the invention, the methane residue is treated by a plasma having energy density lying in the range 15 J/L to 100 J/L generated in a plasma reactor by applying a high voltage electrical signal between an internal electrode and an external electrode of the plasma reactor, the external electrode being cylindrical in shape and surrounding the internal electrode, and at least one of the electrodes being covered in a dielectric material to create a dielectric barrier discharge in the gas mixture and convert part of the methane residue into carbon monoxide.

### TECHNICAL FIELD

The present invention relates to the field of treating gas effluents and more particularly it relates to treating methane residues coming from the combustion of natural gas or any type of liquid fuel (gasoline, diesel oil, heavy oil, etc.).

### STATE OF THE ART

Six greenhouse-effect gases have been identified as having a significant impact on global warming: carbon dioxide CO₂; methane CH₄; nitrous oxide N₂O; hydrofluorocarbons HFC; perfluorocarbons PFC; and sulfur hexafluoride SF₆. Nevertheless, since methane has an impact on atmospheric warming that is 23 times greater than that of CO₂ (for identical mass), it constitutes one of the greenhouse-effect gases that it is most advantageous to diminish.

The combustion of natural gas by so-called fixed or stationary sources (gas turbines, boilers) is cleaner than the combustion of liquid fuels or coal. Nevertheless, the combustion of methane, which at 90% to 95% constitutes the major fraction of natural gas, can be incomplete. Thus, in order to maintain the environmental advantage of such stationary gas sources, it is essential to reduce methane emissions.

At present, the only technique in use for eliminating unburnt methane from gas engines is catalysis. Depending on the operation of the engine, the catalysts used may be of the oxidation type (for lean-fuel combustion) or three-way (for stoichiometric combustion).

Combustion with a lean mixture suffers mainly from low exhaust temperatures: the catalyst, based on palladium, needs to have a very large amount of precious metal and needs to be bulky in order to possess sufficient activity. This leads to catalytic converters that are bulky, expensive, and rapidly deactivated by residual sulfur.

Stoichiometric combustion enables the catalyst to operate at a higher temperature. This leads to better activity of the catalyst and reduces poisoning by sulfur because it is possible to use platinum instead of palladium (which is very sensitive to sulfur). In contrast, the catalyst can be subjected to temperatures that are very high and can suffer strong thermal deactivation. In addition, such stoichiometric operation is being used less and less (particularly for high powers) because its efficiency is 15% to 20% lower than that of operating with a lean mixture.

### OBJECT AND SUMMARY OF THE INVENTION

The present invention thus proposes a method that is an alternative to present methods for eliminating unburnt methane in any type of combustion source, such as boilers, engines, and in particular homogeneous compressed charge ignition (HCCl) engines or gas engines.

This object is achieved by a method of treating a methane residue in a gas mixture, said method comprising a step of introducing said gas mixture into a plasma reactor and a step of generating a plasma in the plasma reactor, wherein: the gas mixture introduced into the plasma reactor has a temperature lying in the range 200° C. to 500° C. and includes at least methane at a concentration in the range 50 parts per million (ppm) to 2500 ppm and oxygen at a concentration lying in the range 0.5% to 12% by volume; and wherein a plasma having energy density lying in the range 15 joules per liter (J/L) to 100 J/L is generated during the plasma generation step by applying a high voltage electrical signal between an internal electrode and an external electrode of said plasma reactor, said external electrode being cylindrical in shape and surrounding the internal electrode, and at least one of said electrodes being covered in a dielectric material for creating a dielectric barrier discharge in the gas mixture and converting part of the methane residue into carbon monoxide.

Thus, firstly, treating the methane residue by a cold plasma with energy density lying in the range 15 J/L to 100 J/L advantageously enables the methane residue to be converted into carbon monoxide without generating hydrocarbons.

The energy density range of 15 J/L to 100 J/L is particularly well adapted for treating a gas mixture including at least methane at a concentration lying in the range 50 ppm to 2500 ppm, and oxygen at a concentration lying in the range 0.5 W to 12% by volume.

Secondly, the fact that one or the other of the electrodes of the plasma reactor is covered in a dielectric enables a dielectric barrier discharge to be created in the gas mixture within the plasma reactor. This has the advantage of limiting current through the plasma and of providing streamers that enable very high energy electrons to be obtained without significant transfer of heat.

Advantageously, it is also possible to treat a large fraction of the species contained in the plasma reactor even though the volume of each streamer remains very small compared to the volume of the reactor.

According to a characteristic of the present invention, the plasma has energy density lying in the range 36 J/L to 58 J/L.

This energy density range is advantageously selected to avoid parasitic reactions, such as the formation of NOₓ at high temperature. Thus, for a given temperature (e.g. 475° C.), a plasma energy density lying in the range 36 J/L to 58 J/L enables a better compromise to be obtained between unwanted formation of NOₓ and methane conversion.

In an implementation of the present invention, the mixture from the plasma reactor is subsequently introduced into a catalytic device having a catalyst for converting the residual mixture into carbon dioxide.

In another implementation of the present invention, the catalyst is deposited in the plasma reactor.

Thus, by coupling a cold plasma with catalytic oxidation of residual methane, it is not necessary to heat the gas mixture for treatment above its natural temperature.

According to another characteristic of the present invention, said catalyst is an oxide of the alumina or silica type, or a mixture of both.

According to another characteristic of the present invention, the catalyst is selected from catalysts based on the following metals: Pt 0.1% to 1% by weight, Pd 0.1% to 2% by weight, or a mixture of both.

According to another characteristic of the present invention, the gas mixture further comprises water at a concentration lying in the range 2% to 15% by volume.

Unlike traditional methods where water has an inhibitor effect on the catalyst, the presence of water in accordance with the present invention has a promoter effect on the overall oxidation reaction. Thus, the conversion of methane with the plasma in combination with the catalyst is improved by the presence of water. In particular, water coming from the combustion of a fuel in the gaseous or liquid state lies behind the creation of highly reactive radicals such as OH^{•} which have the effect of increasing the conversion ratio of the methane at the outlet from the catalytic device or at the outlet from the plasma reactor when it includes the catalyst.

The present invention also provides the use of the above method for treating the methane residue of a gas mixture coming from the combustion of natural gas or of a liquid fuel or from a stationary or moving combustion source, possibly constituted by an engine or a boiler, for example.

### BRIEF DESCRIPTION OF THE DRAWINGS

The characteristics and advantages of the present invention appear better from the following description made by way of non-limiting indication and with reference to the accompanying drawings, in which:

FIG. 1 is a diagrammatic view showing a device of the invention for treating unburnt methane;

FIG. 2 is a graph plotting methane conversion as a function of temperature in the FIG. 1 device;

FIG. 3 is a graph plotting NOₓ concentration as a function of temperature for various energy densities;

FIGS. 4A and 4B are graphs plotting methane conversion as a function of temperature for various energy densities;

FIGS. 5A, 5B, and 5C are graphs plotting methane conversion as a function of temperature with or without the addition of an Al₂O₃ catalyst;

FIG. 6 is a graph plotting the concentration of NOₓ as a function of temperature for various energy densities with or without the addition of an Al₂O₃ catalyst;

FIGS. 7A and 7B are graphs plotting methane conversion as a function of temperature for various energy densities with or without the addition of a Pt/Al₂O₃ catalyst; and

FIG. 8 is a graph plotting methane conversion in the presence of water as a function of temperature for various energy densities with or without the addition of a Pt/Al₂O₃ catalyst.

### DETAILED DESCRIPTION OF PREFERRED EMBODIMENTS

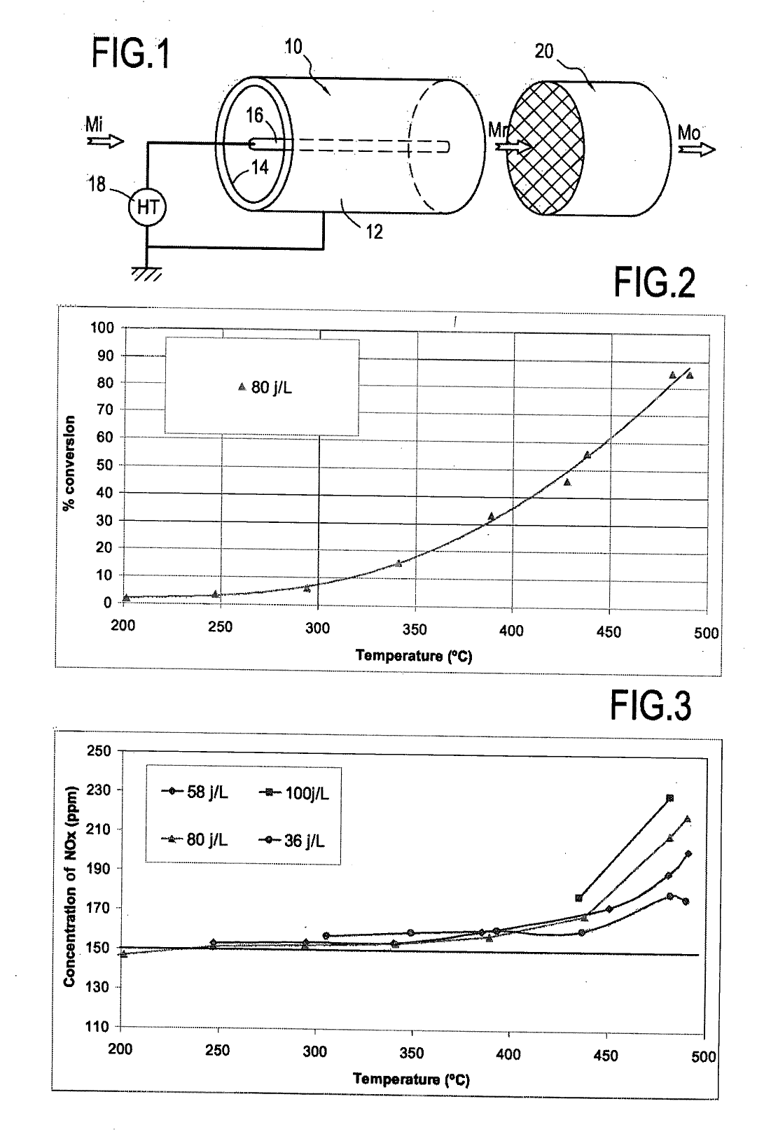

FIG. 1 is a diagram showing a device for treating unburnt methane and designed to be placed at the outlet from a stationary engine such as a gas boiler, for example.

The device essentially comprises a plasma reactor 10 in which a dielectric barrier discharge (DBD) is applied to the gas mixture coming from the engine and including a methane residue for treatment. DBD type discharges differ from conventional direct discharges by the fact that they have at least one electrode covered in a dielectric material (glass, plastic, ceramic, . . . ). This configuration serves to limit current in the plasma. As in all DBD systems, the plasmas generated are made up of a multitude of filamentary microdischarges known as “streamers”. These have an apparent diameter of about 150 micrometers (μm) and they are distributed randomly and perpendicularly to the axis of the reactor. The great advantage of DBDs for chemical applications is directly associated with the very nature of streamers that serve to provide electrons at very high energy without significant transfer of heat. Furthermore, it is possible to treat the methane residue and a large fraction of derived species, and in particular formaldehyde, even if the volume occupied by each streamer remains very small compared with the volume of the reactor.

The plasma reactor 10 used is preferably of the wire and cylinder type having a cylindrical external electrode 12, e.g. constituted by a brass grid and covered on its inside face in a dielectric 14, and an internal electrode 16 in the form of a wire mounted on the axis of the external electrode 12. The length of the electrodes can be adjusted, thereby determining the volume of the plasma reactor 10. These two electrodes 12 and 16 are connected to a high voltage (or high tension) generator 18 operating at a frequency that is adapted to produce a pulsed electrical discharge between the two electrodes presenting predetermined energy density lying in the range 15 J/L to 100 J/L.

Downstream from the plasma reactor 10, there is placed a catalytic device 20 of conventional structure comprising a catalyst for catalytically treating the residual mixture Mr that results from the preceding treatment in the plasma reactor 10. The catalyst is preferably of the Pt/Al₂O₃ or of the Pd/Al₂O₃ type, having a content of Pt by weight lying in the range 0.1% to 1% or of Pd in the range 0.1% to 2%. However a catalyst based on some other metal such as Rh, Au, or Ag, or a combination of these metals with content lying in the range 0.1% to 2% by weight, could also be envisaged.

The operation of the treatment method implemented in the FIG. 1 device is as follows. The gas mixture Mi coming from a stationary engine at a temperature lying in the range 200° C. to 500° C. and including unburnt methane at a concentration lying in the range 50 ppm to 2500 ppm and oxygen constituting 0.5% to 12% by volume is introduced into the reactor 10. Under the action of the electric discharge produced between the two electrodes 16 and 12 of the reactor 10 by the high voltage generator 18, the gas mixture is transformed into a plasma.

FIG. 2 shows that with CH₄ at a concentration of 1000 ppm and an energy density of 80 J/L, the plasma effect then converts 80% of the methane when the temperature is 475° C. The optional presence of CO₂ (8% by volume in the example shown) in the gas mixture Mi has no effect on methane conversion which begins to take place at low temperatures (200° C.). The majority product of the reaction is carbon monoxide CO, with CO formation even being greater than CH₄ conversion. This excess CO comes from the plasma converting CO₂, when present, into CO. Thus, CO₂ leads to CO^{•} and O^{•} leading to CO in the gaseous phase. At the outlet from the reactor 10, the residual mixture Mr can be introduced into the catalytic device 20 which outputs a mixture Mo in which the initial unburnt methane has been converted practically completely into carbon dioxide.

There follows a description of the operating conditions in which tests have been carried out.

In one implementation, the plasma reactor 10 and the catalytic device 20 were integrated with each other. Thus, the reactions took place at atmospheric pressure in a plasma reactor 10 having the catalyst deposited thereon. The reactor had the gas mixture for treatment passing therethrough. The gas flow rate was set at 250 milliliters per minute (mL/min). The mass of catalyst was deposited on a sintered piece and depends on the selected value for VVH (smoke volume/catalyst volume/hour). The catalytic activity was measured at 200° C. to 500° C. in successive temperature stages. The activity at each stage was measured for about 15 minutes (min).

The external electrode 12 of the plasma reactor 10 was a quartz tube comprising a sintered piece of zero porosity with an inside diameter equal to 12 millimeters (mm) and a thickness of 1 mm, and the internal electrode 16 was a tungsten rod having a diameter of 0.9 mm. The electrodes were 15 centimeters (cm) long. The distance between the electrodes was 5.5 mm. The high voltage generator 18 delivered pulses at a voltage of about 20 kilovolts (kV) and a frequency that was variable up to 200 hertz (Hz), thus providing the plasma with the desired energy density in the range 5 J/L to 100 J/L.

A micro-chromatograph (e.g. the Agilent G2890A model) fitted with a thermal conductivity detector placed at the outlet from the reactor was used to obtain various measurement results. That apparatus is capable in particular of detecting residual methane. The possible formation of CₓY_{y}O_{z} and R—NOₓ can be tracked using a gas phase chromatograph (e.g. Agilent models 6890N and 5973N). The formation of CO₂, N₂O, NO, and NOₓ was tracked by means of specific detectors (e.g. the models Siemens Ultramat 6E and Siemens CLD 700 AL).

The various examples described below were performed on a mixture for treatment that had the following composition:

| | |
|---|---|
| CH₄: | 1000 ppm |
| NO: | 150 ppm |
| O₂: | 7 vol. % |
| CO₂: | 8 vol. % |
| H₂O: | 3 vol. % when present |

It made it possible to assess the essential parameters involved in the treatment method of the invention. However, these examples should naturally not be considered as being limiting and the results obtained remain generally valid with any gas mixture for treatment and of composition that remains within the following ranges:

| | |
|---|---|
| CH₄: | 50 to 2500 ppm |
| NO: | 0 to 4000 ppm |
| O₂: | 0.5% to 12% by volume |
| CO₂: | 0% to 25% by volume |
| H₂O: | 2% to 15% by volume |

### Example 1

### Effect of Energy Density on Methane Conversion

As shown in Table 1, the energy density of the plasma has an effect on methane conversion.

TABLE 1
Methane conversion as a function of plasma
energy density at 450° C.

| | | | | | |
|---|---|---|---|---|---|
| Energy density (J/L) | 15 | 36 | 58 | 80 | 100 |
| Methane conversion (%) | 18 | 39 | 50 | 63 | 75 |

In addition, the plasma creates NOₓ (FIG. 3) in the form of NO₂ from 375° C., and the greater the energy density, the more NOₓ is formed. In the absence of CO₂, the formation of NOₓ also begins at about 375° C. The best compromise between NOₓ formation and methane conversion is obtained for the densities 36 J/L and 58 J/L. It should be observed that the curves present an offset, that is merely the result of an initial presence of 150 ppm of NOₓ in the reaction mixture.

### Example 2

### Effect of Water on Methane Conversion

Water has a promoter effect on methane conversion by plasma in the presence of a catalyst, as shown in FIG. 2, unlike its well-known inhibitor effect on catalysts.

TABLE 2
Effect of water on the activity of the plasma in
oxidizing methane at 450° C.

| | Energy | |
|---|---|---|
| | density (J/L) | |
| | 36 | 58 |
| Methane conversion (%) without H₂O | 39 | 50 |
| Methane conversion (%) with H₂O at 3% by volume | 48 | 64 |

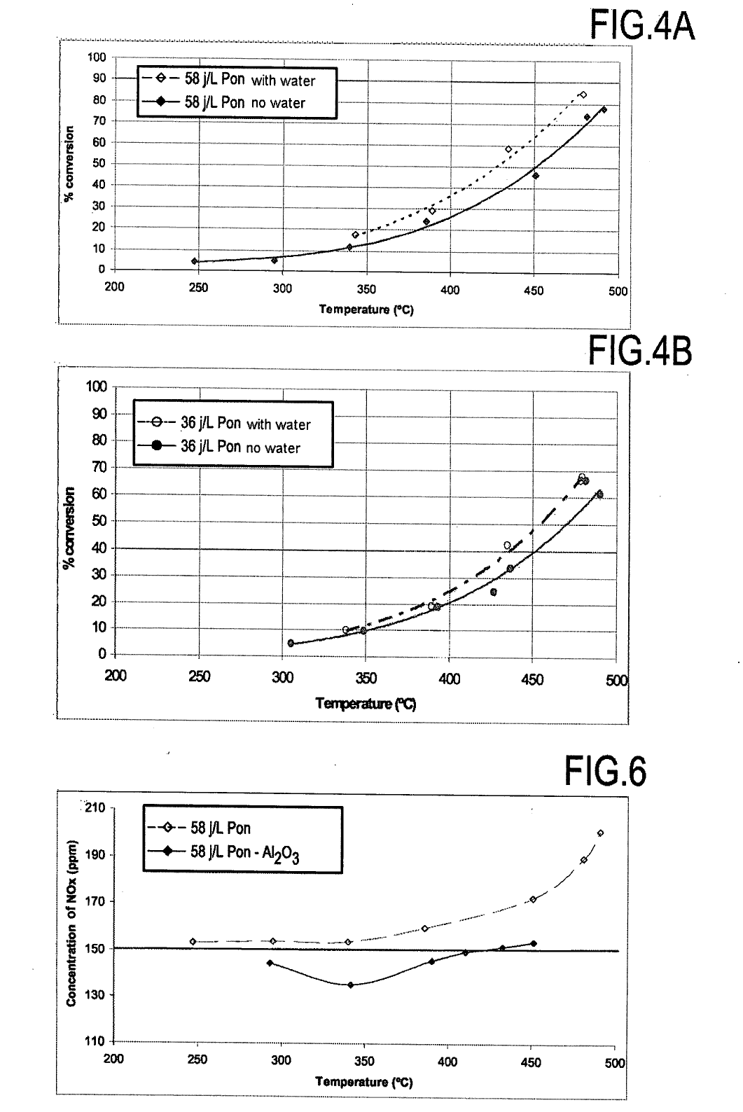

FIGS. 4A and 4B show the results obtained for temperatures lying in the range 250° C. to 500° C. with energy densities of 36 J/L and 58 J/L.

### Example 3

### Catalytic Effect of Alumina (Al₂O₃)

The alumina studied was gamma alumina (reference catalyst support), having a specific surface area of 250 square meters per gram (m²/g).

It is known that alumina on its own is weakly active in oxidizing methane from 425° C. At this temperature, alumina oxidizes CO into CO₂.

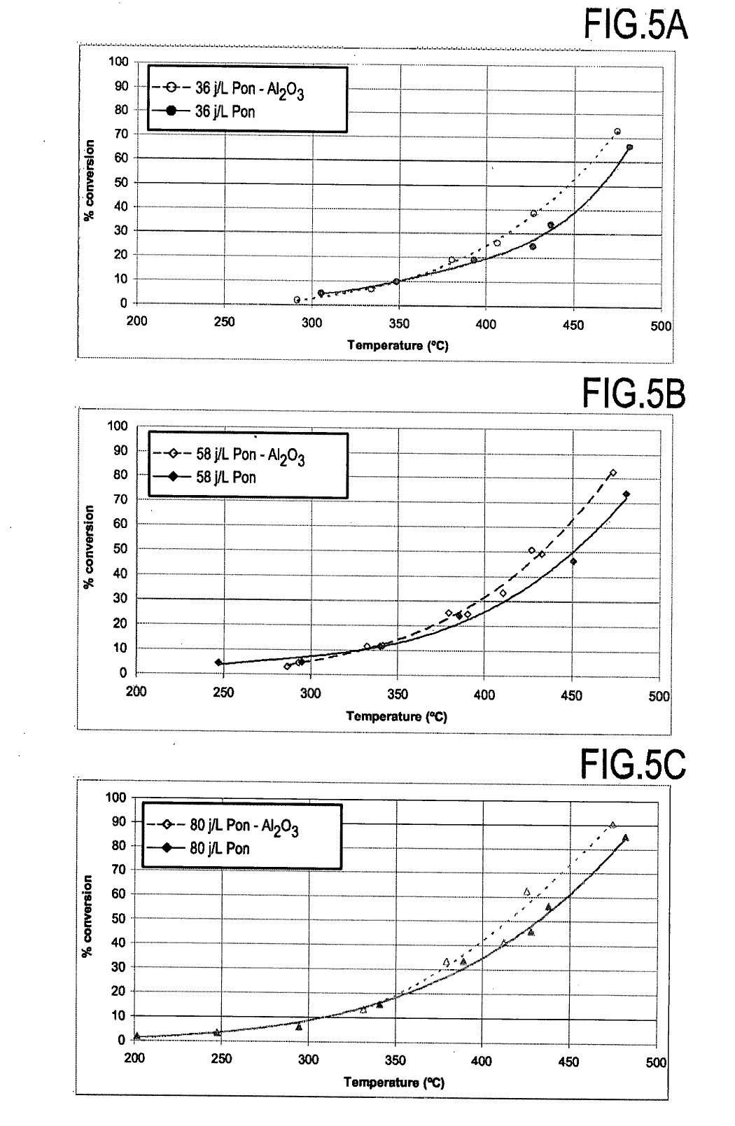

With the invention, and as shown in Table 3, alumina presents a catalytic effect. Thus, at 450° C., more than 50% methane conversion was obtained with a plasma plus alumina system (D=36 J/L and VVH=20,000 h⁻¹), whereas only 39% was obtained with the plasma on its own. Furthermore, conversion increased significantly with energy density (FIGS. 5A, 5B, and 5C). It should be observed that the formation of NOₓ was greatly reduced at high temperature when using plasma and alumina together, as compared with plasma on its own (FIG. 6).

TABLE 3
Effect of plasma and Al₂O₃ (alumina) together on
methane conversion at 450° C.

| | Energy | | |
|---|---|---|---|
| | density (J/L) | | |
| | 36 | 58 | 80 |
| Methane conversion (%) plasma alone | 39 | 50 | 63 |
| Methane conversion (%) plasma + alumina | 53 | 63 | 74 |

Similar results (methane conversion increasing with energy density, reduced formation of NOₓ) have been obtained with silica, which enables better conversion for plasma and catalyst together than for the plasma on its own. An alumina-silica mixture further improves these results.

### Example 4

### Effect of the Smoke Volume/Catalyst Volume/Hour (VVH) Ratio on Methane Conversion

As shown in Table 4 comparing results obtained at 20,000 h⁻¹ and 40,000 h⁻¹, the smaller VVH, the more methane conversion increases while NOₓ formation decreases.

TABLE 4
Effect of VVH on CH₄ conversion with and without
plasma and Al₂O₃ (alumina) together

| | T = 450° C. | | | |
|---|---|---|---|---|
| | D = 36 J/L | | | |
| | | Plasma + | | Plasma + |
| | Alumina | alumina | Alumina | alumina |
| | 20,000 h⁻¹ | 20,000 h⁻¹ | 40,000 h⁻¹ | 40,000 h⁻¹ |
| CH₄ conversion (%) | 9 | 53 | 3 | 48 |

### Example 5

### The Effect of Adding 0.36 wt % Pt/Al₂O₃ Catalyst

The Pt/Al₂O₃ catalyst deactivates at high temperature due to the metal phase sintering, so all of the tests were carried out after the catalytic activity had stabilized.

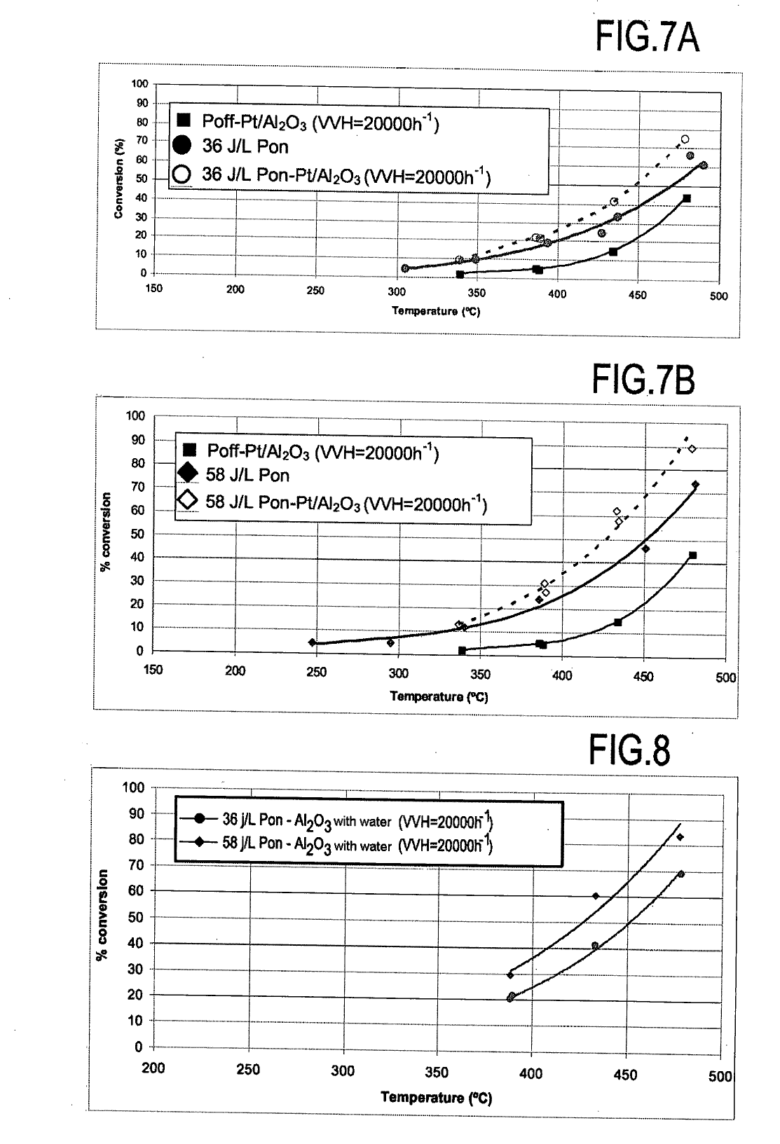

It can be seen that the plasma/Pt/Al₂O₃ system is considerably more active in oxidizing methane than is the plasma on its own, as shown in Table 5. Methane conversion increases very strongly with the plasma/catalyst system (FIGS. 7A and 7B). Furthermore, conversion increases significantly with plasma energy density (FIG. 8).

It should be observed that the levels of methane conversion obtained with plasma on its own and with the plasma/catalyst system are relatively close together. Nevertheless, with the plasma/catalyst system, the only reaction product was CO₂ (no partially-oxidized species or CO were detected).

TABLE 5
Effect of adding a catalyst comprising 0.36 wt %
Pt/Al₂O₃ on CH₄ conversion at 450° C.

Energy density

| | 36 J/L | 58 J/L |
|---|---|---|
| Methane conversion (%) plasma alone | 39 | 50 |
| Methane conversion (%) plasma + | 54 | 70 |
| 0.36 wt %/Pt/Al₂O₃ catalyst | | |

### Example 6

### The Effect of Adding 0.50 wt % Pd/Al₂O₃ and 1.66 wt % Pd/Al₂O₃ Catalyst

It is known that the activity in oxidizing methane of Pd/Al₂O₃ catalysts is relatively weak (48 W for 1.66 wt % Pd/Al₂O₃ catalyst).

With the invention, the plasma and catalyst together serve to increase methane conversion as shown in Table 6. Thus, at 450° C., 64% conversion of the methane was obtained with the plasma/1.66 wt % Pd/Al₂O₃ system (D=58 J/L and VVH=40,000 h⁻¹).

TABLE 6
The effect of adding 0.5 wt % Pd/Al₂O₃ and
1.66 wt % Pd/Al₂O₃ catalysts on the
conversion of methane at 450° C.

Energy density

| | 36 J/L | 58 J/L |
|---|---|---|
| Methane conversion (%) plasma alone | 39 | 50 |
| Methane conversion (%) plasma + 0.5 wt % | 68 | 71 |
| Pd/Al₂O₃ catalyst | | |
| Methane conversion (%) plasma + 1.66 wt % | 59 | 64 |
| Pd/Al₂O₃ catalyst | | |

Thus, the use of a cold plasma for treating emissions of unburnt methane coming from stationary engines is found to be effective from 200° C. It should also be observed that water has a promoter effect on the conversion of methane by the plasma in the presence of a catalyst. Furthermore, with the Pt/Al₂O₃ catalyst, the plasma and catalyst together turn out to be particularly advantageous, given that platinum-based catalysts are already installed on stationary engines for treating CO. Under such circumstances, the structure of the invention amounts merely to adding a plasma generator 10 upstream from the catalytic device 20. In this other embodiment, the mixture from the plasma generator is introduced into the catalytic device that contains a catalyst for converting the residual mixture into carbon dioxide.

What is claimed is:

1. A method of treating a methane residue in a gas mixture, said method comprising a step of introducing said gas mixture into a plasma reactor and a step of generating a plasma in the plasma reactor, wherein:
the gas mixture introduced into the plasma reactor has a temperature lying in the range 200° C. to 500° C. and includes at least methane at a concentration in the range 50 ppm to 2500 ppm and oxygen at a concentration lying in the range 0.5% to 12% by volume; and
wherein a plasma having energy density lying in the range 15 J/L to 100 J/L is generated during the plasma generation step by applying a high voltage electrical signal between an internal electrode and an external electrode of said plasma reactor, said external electrode being cylindrical in shape and surrounding the internal electrode, and at least one of said electrodes being covered in a dielectric material for creating a dielectric barrier discharge in the gas mixture and converting part of the methane residue into carbon monoxide.

2. A treatment method according to claim 1, wherein the plasma has energy density lying in the range 36 J/L to 58 J/L.

3. A treatment method according to claim 1, wherein the mixture from the plasma reactor is subsequently introduced into a catalytic device having a catalyst for converting the residual mixture into carbon dioxide.

4. A treatment method according to claim 1, wherein the catalyst is deposited in the plasma reactor.

5. A treatment method according to claim 3, wherein said catalyst is an oxide of the alumina or silica type, or a mixture of both.

6. A treatment method according to claim 3, wherein the catalyst is selected from catalysts based on the following metals: Pt 0.1% to 1 W by weight, Pd 0.1% to 2 W by weight, or a mixture of both.

7. A treatment method according to claim 3, wherein the gas mixture further comprises water at a concentration lying in the range 2% to 15% by volume.

8. The use of the treatment method according to claim 1, wherein said gas mixture comes from the combustion of natural gas or a liquid fuel or from a stationary or moving combustion source.

9. A use according to claim 8, wherein source is an engine.

10. A use according to claim 8, wherein source is a boiler.
